(19) United States
(12) Patent Application Publication
(10) Pub. No.: US 2016/0164826 A1
(43) Pub. Date: Jun. 9, 2016

(54) Policy Implementation at a Network Element based on Data from an Authoritative Source

(71) Applicant: Cisco Technology, Inc., San Jose, CA (US)

(72) Inventors: Wolfgang Arno Riedel, Erlangen (DE); Mark Montanez, Gilroy, CA (US); Saravanan Radhakrishnan, Bangalore (IN); Ralph Edward Droms, Concord, MA (US); David J. Zacks, Vancouver (CA); Rohit Kumar Suri, Fremont, CA (US)

(21) Appl. No.: 14/725,381

(22) Filed: May 29, 2015

(30) Foreign Application Priority Data
Dec. 4, 2014 (IN) 3894/MUM/2014

(51) Int. Cl. H04L 29/12; G06F 17/30; H04L 12/26

(52) U.S. Cl. CPC H04L 61/1511; H04L 43/0876; G06F 17/30477; G06F 17/30864

(57) ABSTRACT

In an embodiment, at a network element in a network, a domain name query is intercepted from a client. Metadata associated with a network application or service that is the object of the domain name query is obtained from a domain name system server. A policy is determined to enforce, based on the metadata, and the policy is enforced with respect to the client's access of the network application or service.

### PRIORITY CLAIM

This application claims priority to Indian Provisional Patent Application No. 3894/MUM/2014, filed Dec. 4, 2014, and entitled “POLICY IMPLEMENTATION BASED ON DATA FROM AN AUTHORITATIVE SOURCE,” the entirety of which is incorporated herein by reference.

### TECHNICAL FIELD

The present disclosure relates to the application of policies to network elements, applications and services.

### BACKGROUND

It is often desirable to control the interaction between a network node and a particular network service or application by enforcing particular policies. Such policies may define security measures, delay requirements, jitter requirements, and/or bandwidth requirements for example, thereby regulating the interactions between the client and the service or application. To intelligently and efficiently apply a policy, a given application or service may need to be identified and categorized, such that all applications or services in a particular category will have one or more particular policies applied to them. Today, many applications operate over a common transport protocol such as the Hypertext Transfer Protocol (HTTP), and therefore it is possible to identify an application by the use of highly resource-intensive Deep Packet Inspection (DPI) methods. These approaches may not be reasonable on most forwarding systems, however, in view of speed and/or scaling considerations. In addition, in the future most applications may communicate in a more confidential way by the use of encryption for network traffic, which renders DPI methods ineffective as a means of application identification.

At the same time, customer requirements for differentiated traffic treatment continues to grow as more and more functions are placed onto the common internet protocol (IP) network infrastructure. Today, the requirements for speed and for encryption make it difficult for network elements to differentiate traffic flows. This can limit the implementation of policies that could otherwise allow the service levels that customers seek.

### BRIEF DESCRIPTION OF THE DRAWINGS

FIG. 1 illustrates obtaining an IP address from a DNS server, according to an embodiment.

FIG. 2 illustrates a reverse query to obtain metadata, according to an embodiment.

FIG. 3 is a flowchart illustrating the policy selection process, according to an embodiment.

FIG. 4 illustrates obtaining metadata from a local DNS server, according to an embodiment.

FIG. 5 is a flowchart illustrating obtaining metadata from a local DNS server, according to an embodiment.

FIG. 6 illustrates the role of a local DNS server in the addition of metadata to a response, according to an embodiment.

FIG. 7 illustrates reverse and forward queries to a local DNS server to obtain metadata, according to an embodiment.

FIG. 8 is a flowchart illustrating reverse and forward queries to a local DNS server to obtain metadata, according to an embodiment.

FIG. 9 illustrates obtaining metadata through a TCP SYN/ACK process, according to an embodiment.

FIG. 10 is a flowchart illustrating the TCP SYN/ACK process, according to an embodiment.

FIG. 11 illustrates a recursive process for obtaining metadata via multiple network elements, according to an embodiment.

FIGS. 12A and 12B are a flowchart illustrating the recursive process for obtaining metadata, according to an embodiment.

FIG. 13 is a flowchart illustrating policy generation and distribution at a software defined network (SDN) controller, according to an embodiment.

FIG. 14 illustrates an example of a binding table, according to an embodiment.

FIG. 15 illustrates a computing environment in a network element, according to an embodiment.

FIG. 16 illustrates a computing environment in an SDN controller, according to an embodiment.

FIG. 17 illustrates a computing environment in a domain name server, according to an embodiment.

### DESCRIPTION OF EXAMPLE EMBODIMENTS

### Overview

Methods and systems are described here for implementing network traffic policies. In an embodiment, at a network element in a network, a domain name query is intercepted from a client. Metadata associated with a network application or service that is the object of the domain name query is obtained from a domain name system server. A policy is determined to enforce, based on the metadata, and the policy is enforced with respect to the client's access of the network application or service.

### Example Embodiments

Methods and systems are disclosed herein for utilizing DNS and DNS resource records (RRs) to provide metadata that can be used to identify applications and services being accessed by a client. The metadata may include, for example and without limitation, an identifier for the application or service, network parameters, and/or business requirements. In addition to an application or service identifier, the metadata may include a bandwidth requirement, a signal loss requirement, a delay requirement, and a jitter requirement for example. Examples of business requirements may include quality of service (QoS), security, and throughput requirements, for example. The metadata allows for the selection of appropriate network policies for traffic handling. These policies can then be applied to network traffic by entities that serve as policy enforcement points, such as application programs, operating systems, classification engines, forwarding engines, and/or network elements, such as switches and routers. Using the destination internet protocol (IP) address (or destination IP address plus port number) as a discriminator, the processing described herein categorizes IP traffic for policy identification and application by leveraging metadata about applications and services, wherein the metadata is distributed by a DNS.

The description below may apply to any type of traffic policy. Examples of traffic policies may include security policies, quality of services (QoS) policies, class of service (CoS) policies, differentiated service policies, policies that apply to generic types of traffic (e.g., voice, interactive, video, bulk, and transactional traffic), service chaining policies, and policies relating to network function virtualization (NVF). In an embodiment, a policy may be specified using a policy language. One example of such a policy language is the Cisco Common Classification Policy Language (C3PL).

Using DNS resource records to store metadata to identify applications and services provides a common authoritative source (AS) for this information, one that can be leveraged by all enforcement points in the network via this common point of reference and administration. In an embodiment, the actual traffic behavior enforcement is accomplished with individual policies on individual devices in a distributed way, where these policies are matched against applications and services by leveraging the common metadata repository in DNS. In an embodiment, the metadata may be provided to the DNS by the party that provisions the application or service.

This solution can utilize and work within existing deployed DNS infrastructures. It also utilizes existing traffic management mechanisms in enforcement points. The embodiments described herein employ the categorization within DNS of applications and services by destination IP address or destination IP address and port number, coupled with metadata about these applications. This metadata can then be leveraged by the network enforcement points such as network elements for policy application.

### Accessing Metadata

In various embodiments, authoritative metadata for a given application or service could exist in one of three places: the Internet (for applications or services outside a local network), the cloud (for cloud-based applications or services), and locally with respect to a local network or data center. Clients as discussed herein could be using any of these three types of applications or services. Clients are directed to an IP address of a local DNS server. If the metadata is not available at the local DNS server, a recursive process may take place in which outside DNS servers may be accessed for the metadata, where the outside DNS servers are authoritative for particular respective DNS zones.

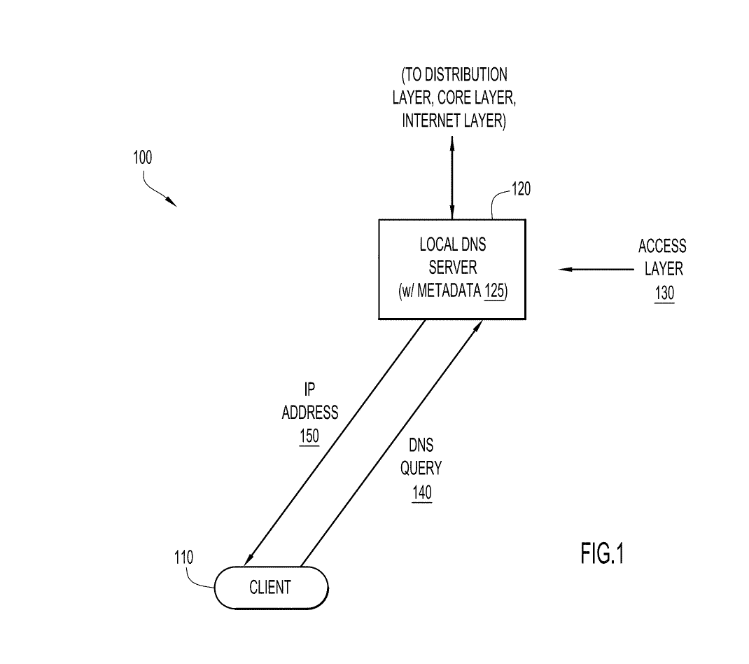

If the application or service is available locally, the client may look up an IP address via DNS for which the client's local internal DNS server is authoritative. This is illustrated in FIG. 1, according to an embodiment. A client 110 first sends a DNS query to a local DNS server 120 in the access layer 130. The client 110 may be any computing device (such as a personal computer, laptop, tablet computer, or smartphone, as examples and without limitation), or a process running on such a device. The local DNS server 120 then returns a record containing an IP address 150 for the requested server. In an embodiment, the local DNS server 120 is in communication with additional communications and computing infrastructure at distribution, core, and internet layers of the illustrated network. In other embodiments, query responses from the local DNS server 120 can contain multiple records with respective multiple addresses, and can include a lower time-to-live (TTL) value to avoid having the client 110 (or the local DNS server 120) cache the entry for an excessive amount of time. In the illustrated embodiment, the local DNS server stores metadata 125 related to the application or service being sought by the client 110. The metadata 125 may be stored in a record that is linked to one or more other records related to the application and service. In an embodiment, the metadata 125 may be originated by a provider of the application or service. The use of this metadata will be described in greater detail below.

Queries can also be sent to look up the address for a name for which the local DNS 120 is not authoritative. This will cause recursion for the name lookup via a DNS tree, with the local DNS ultimately replying back to the client with the address thus obtained. The DNS tree includes network components at higher levels of the network (e.g., at the distribution, core, and internet layers). The recursion process will be described in greater detail below.

Generally, the process described above with respect to FIG. 1 is a form of a forward lookup. In an embodiment, a forward lookup retrieves a domain name's associated A or AAAA record that contains an Internet Protocol (IP) address (e.g., IPv4 or IPv6 address) through a DNS request to a DNS server or other network element. Additionally a text (TXT) record associated with the domain name may be retrieved. DNS authoritative source (-AS) metadata can be retrieved as content encoded in the TXT record associated with the domain name. For example, DNS-AS metadata can be stored in a table as content encoded in a TXT record associated with the domain name. Such a table, whose contents may be accessed through a forward lookup, is referred to herein as a forward table.

Reverse lookups are also possible. In an embodiment, a reverse lookup entails an input of an IPv4 or IPv6 address, and retrieves the domain name associated with the IPv4 or IPv6 address. Additionally a TXT record associated with the IPv4 or IPv6 address can be retrieved. For example, DNS-AS metadata can be stored in a table as content encoded in a TXT record associated with the IP address. Such a table, whose contents may be accessed through a reverse lookup, is referred to herein as a reverse table.

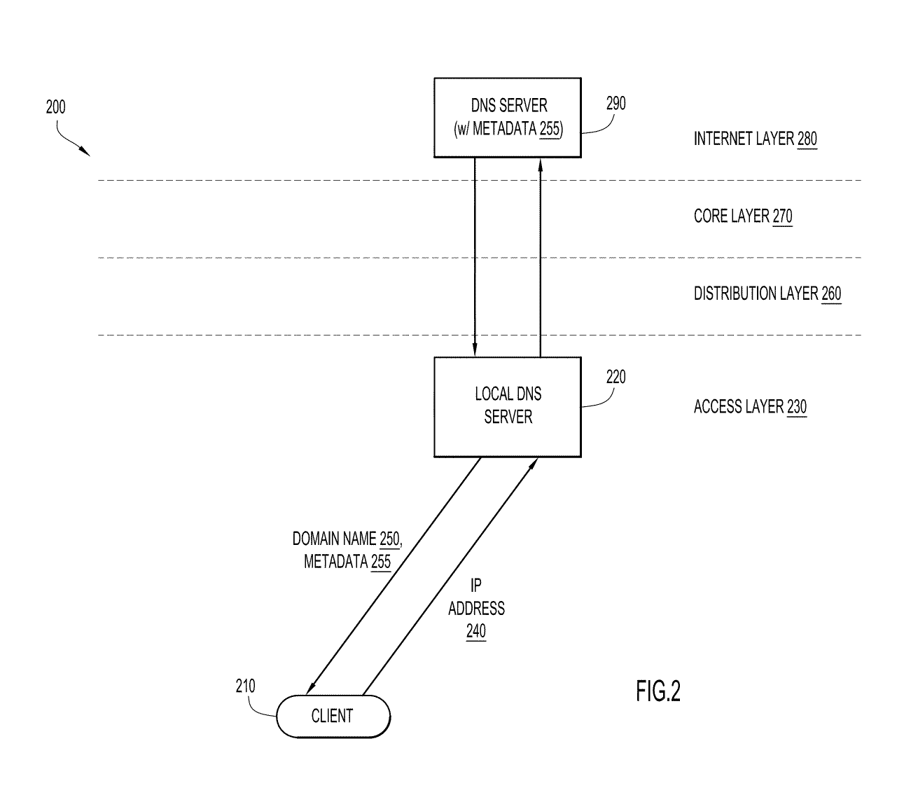

A reverse lookup is illustrated in FIG. 2. In this case, an IP address 240 is provided from a client 210 to a local DNS server 220. The domain name 250 associated with the IP address 240 may be returned as a pointer record. Such a query may be resolved at a DNS server 290 in the internet layer 280, e.g., in the IN-ADDR.ARPA domain. Metadata 255 is stored at DNS server 290 and can be returned with a reverse DNS lookup. Metadata 255 can take the form of text records or other data formats. Such metadata can describe attributes of the application or service. Examples of such metadata may include an identifier for the application (such as the app ID), and requirements for bandwidth, jitter, loss, and delay. In an embodiment, the metadata may be originated by a provider of the application or service and stored at DNS server 290 and/or other DNS servers in the network.

For either lookup process, the retrieval of DNS-AS metadata does not always take place. For example, a TXT record may not be present, or the contents of a retrieved TXT record may not contain DNS-AS metadata. In the case where metadata is not retrieved via an initial forward DNS-AS request, the network element performing the DNS-AS retrieval may perform a reverse lookup, i.e., make a reverse DNS-AS request in an attempt to retrieve DNS-AS metadata from the reverse table. In a case where metadata is not retrieved via an initial reverse DNS-AS request, the network element performing the DNS-AS retrieval may make a forward DNS-AS request in an attempt to retrieve DNS-AS metadata from the forward table. As a result, if DNS-AS metadata is published in either the forward or reverse tables it can be retrieved by a network element seeking to utilize the metadata via a second lookup based on the information retrieved in an initial (forward or reverse) DNS-AS request.

In an embodiment, DNS-AS metadata may be encoded in TXT records published in both the reverse and forward DNS tables. This technique can thus avoid a second lookup that would otherwise be performed if DNS-AS metadata were only encoded in one of the DNS tables (forward or reverse).

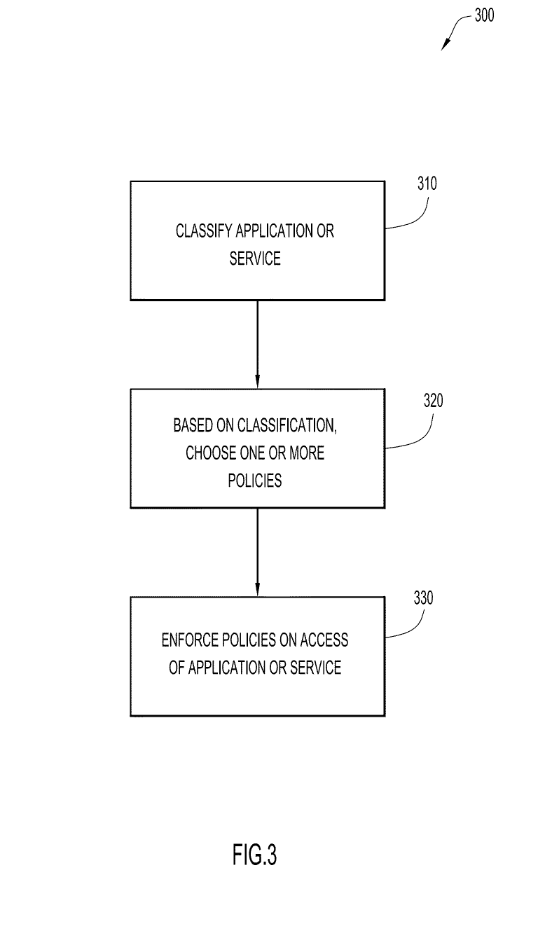

Such metadata can be used to determine one or more policies to be enforced with respect to the client's access of the desired application or service. This process is illustrated generally in FIG. 3, as performed in a network element (e.g., a switch, router, or forwarding engine, which are presented as examples and without limitation) or other policy enforcement point. At 310, the application or service is classified on the basis of the metadata obtained along with a domain name in, for example, a reverse lookup through a DNS server. Using this metadata-based classification, one or more policies are chosen at 320. At 330, the policies are enforced with respect to the client's access of the application or service.

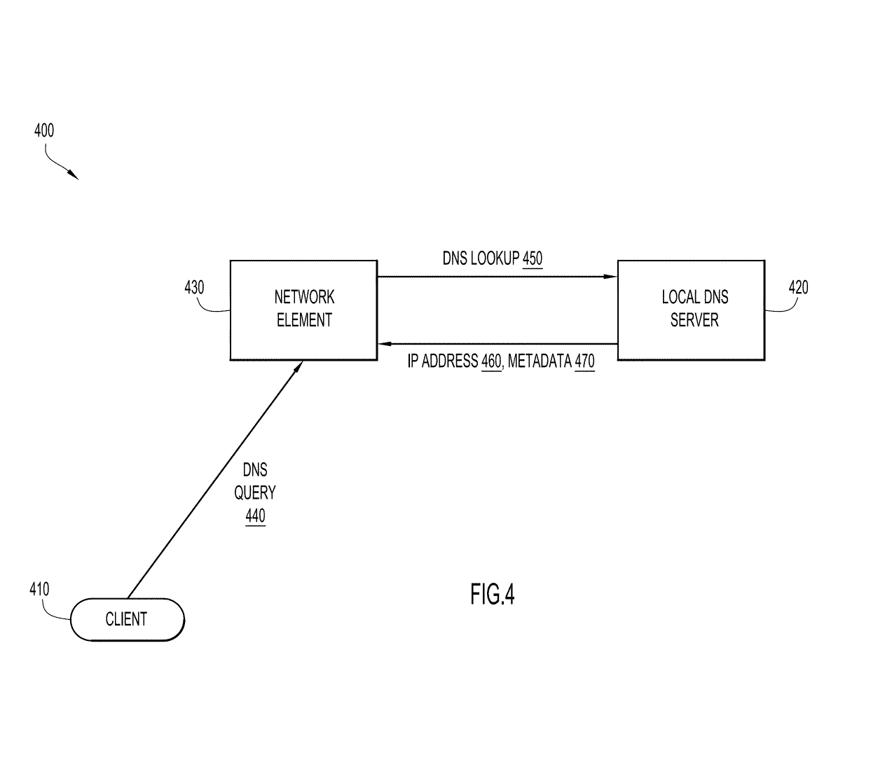

In an embodiment, the process of obtaining the metadata includes interception of a client's initial DNS query. This is illustrated in FIG. 4. The client 410 initiates a DNS query 440 for the application or service it is trying to access. A network element 430, such as a switch or router, intercepts the query 440. The network element 430 may cache the original query 440 of client 410 in an embodiment. The network element 430 originates a DNS lookup 450 for the application or service's metadata 470 (assuming this data has not been previously cached at network element 430). The metadata 470 may take the form of a text record. In an embodiment, the metadata 470 is stored at the local DNS server 420 in the form of one or more resource records. From the metadata 470 of the application or service, one or more policies can be determined before client traffic flow begins. The network element 430 the stores the metadata for the access of the application or service, and releases the client 410's cached DNS query 440 (unmodified) for normal DNS resolution.

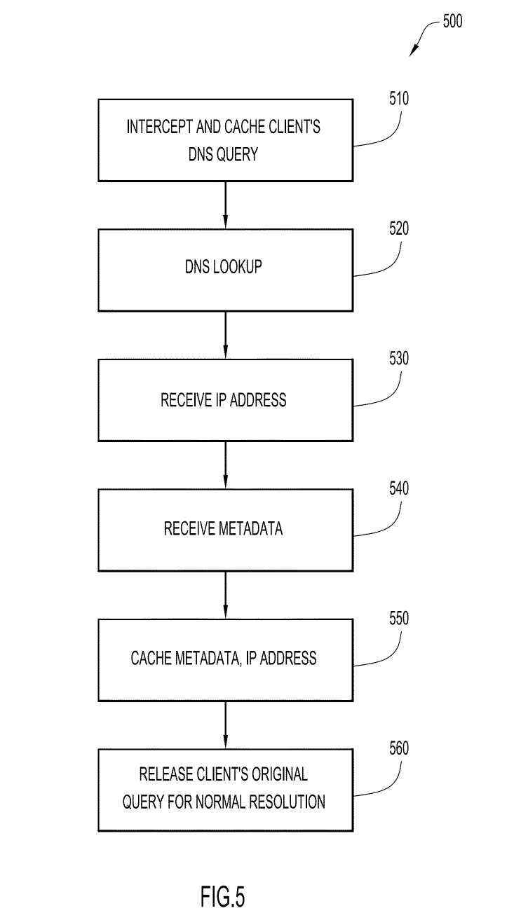

This processing at the network element 430 is further illustrated in FIG. 5, according to an embodiment. At 510, the network element intercepts the DNS query from the client and caches the query. At 520, the network element performs a DNS lookup, starting at a local DNS server. At 530, the network element receives the corresponding IP address and at 540 receives the related metadata. At 550, the metadata and IP address are cached at the network element. At 560, the network element releases the client's original DNS query for normal resolution.

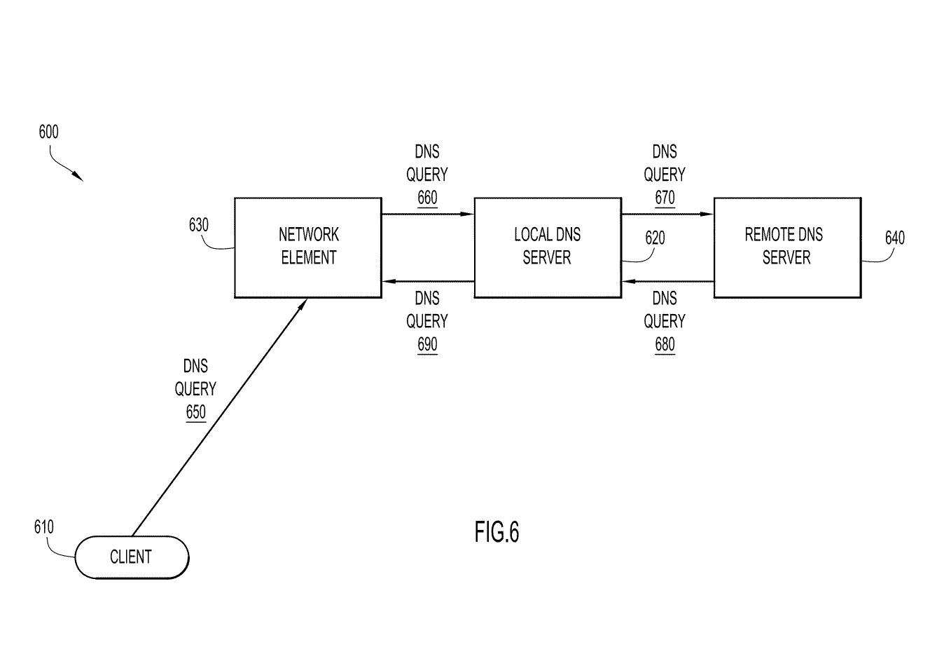

Queries about domain names for which the local DNS server are not authoritative may be forwarded to a remote server for resolution. Remote servers may not provide metadata with their responses to DNS queries, however. In an embodiment, a reply from a remote server is received by the local DNS server that forwarded it. The local DNS server examines the response for metadata. If metadata is not present, the local DNS server inserts the metadata into the response before returning the response. This embodiment is shown in FIG. 6, where a client 610 sends a DNS query 650 to a network element 630. The network element 630 sends the query (as query 660) to a local DNS server 620, which forwards the query (as query 670) to a remote DNS server 640. The remote DNS server 640 then generates a DNS response 680 and sends it to local DNS server 620. The local DNS server 620 examines the response for metadata. If metadata is not present, the local DNS server 620 inserts the metadata into the response. The metadata may be derived from static configuration, analytics or the results of deep packet inspection, for example.

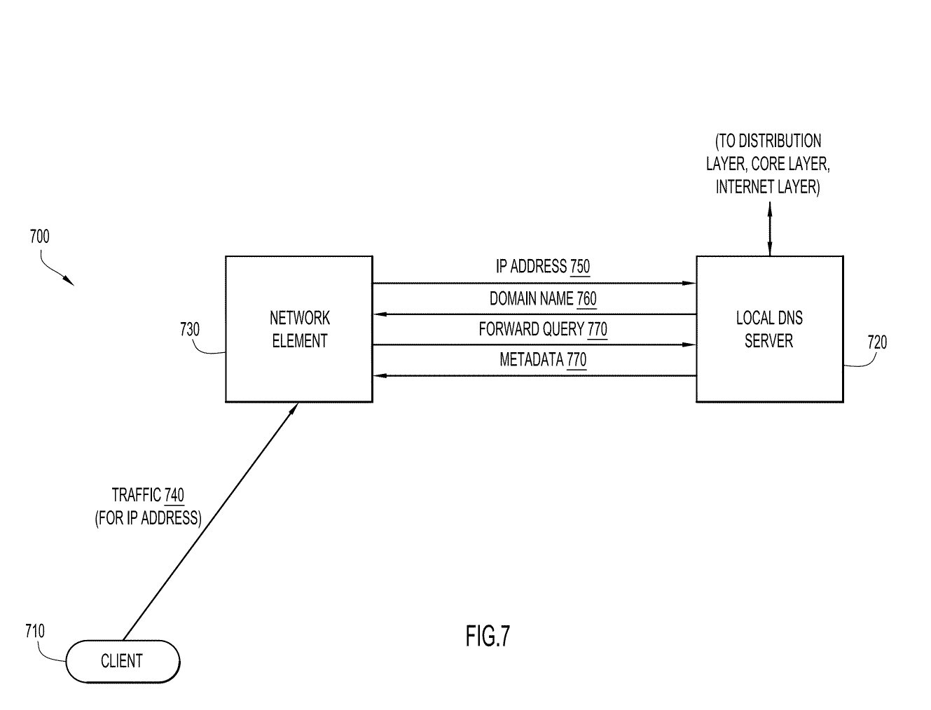

In some situations, the client may begin sending traffic without doing a DNS lookup that is noticed by the network element. This may take place, for example, when a client device wakes up or the network element crashes and reloads. This scenario is illustrated in FIG. 7, according to an embodiment. The client 710 begins to send traffic 740 towards the IP address of the application or service in question. The network element 730 inspects its local data structure (e.g., a local flow table) to determine if it already knows about this traffic flow and if it has metadata that corresponds to the flow. If the metadata is available here, it can be used for selection of an appropriate policy. Otherwise, the network element 730 originates an infrastructure reverse DNS query by sending the IP address 750, to get the domain name 760 associated with this particular IP address 750. The network element then originates an infrastructure forward DNS query 770, by sending the domain name 760 to the local DNS server 720 and thereby receives the associated metadata 780. In an embodiment, the metadata 780 is received in a text record.

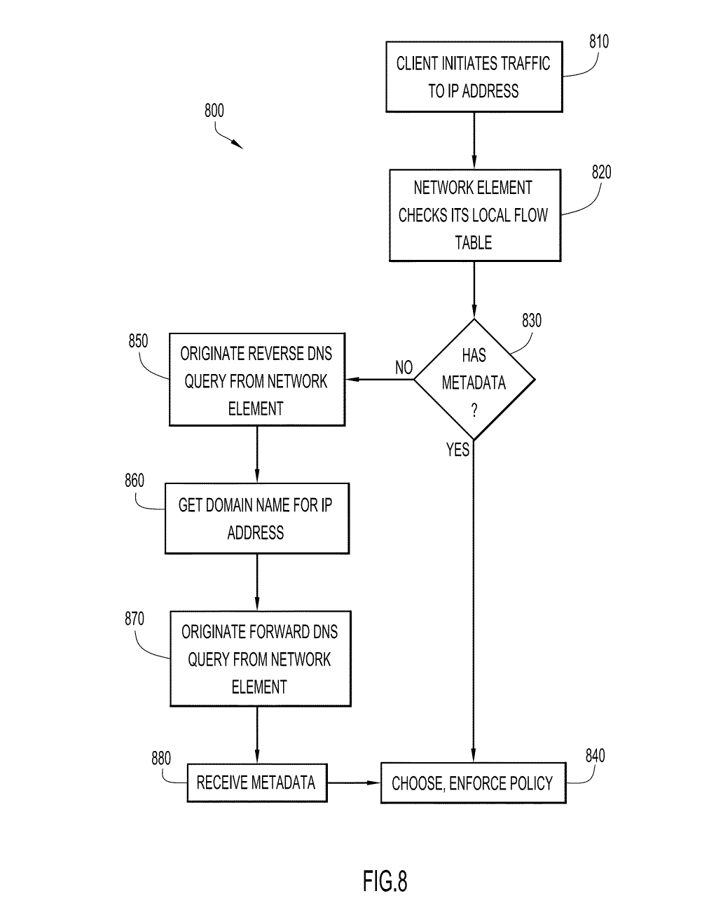

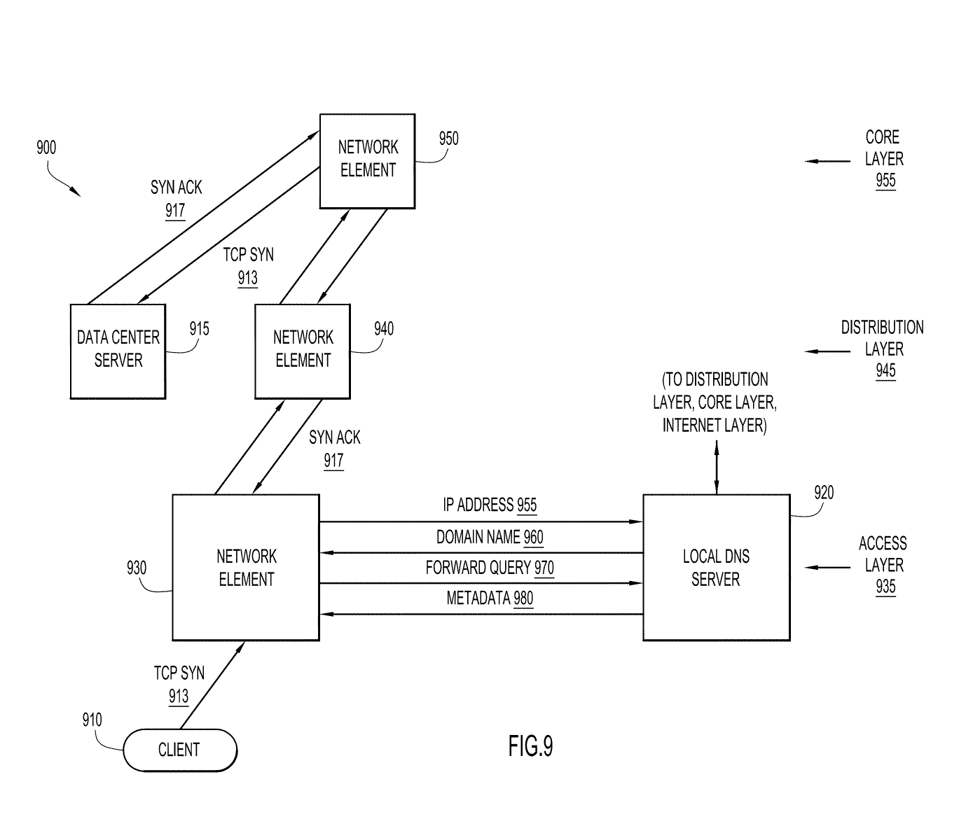

The processing associated with this scenario is illustrated in FIG. 8, according to an embodiment. At 810, the client initiates traffic towards an IP address. At 820, the network element sees the traffic and checks its local flow table. At 830, a determination is made as to whether metadata associated with the IP address is present. If so, then the network element can choose and enforce the appropriate policy at 840. Otherwise, the process continues at 850. Here, a reverse DNS query is initiated from the network element, using the IP address. At 860, the corresponding domain name is received. At 870, a forward DNS query is initiated from the network element. At 880, metadata is received in response. The metadata can then be used to choose and enforce a policy at 840.

In other situations, a network element may lack the necessary hardware resources for flow tracking. In an embodiment, a more lightweight mechanism can be used. Here, a client 910 opens a TCP connection by sending a TCP open message, TCP SYN 913, in this case to a server 915 in a data center. The server replies with an acknowledgement, SYN ACK 917. At this point, it is known that the connection is valid, because the server 915 is responsive and TCP is opening. The packet signature in the SYN ACK message 917 is unique, in that the combination of flags in this packet only appears once in a given TCP connection. This packet is sent to the control plane on the network element 930 attached to the originating host. In the illustrated embodiment, the TCP SYN 913 and SYN ACK 917 are sent via network elements 940 and 950 in distribution layer 945 and core layer 955 respectively.

The network element 930 is configured to start a DNS lookup upon receipt of the SNY ACK message 917. The network element 930 then originates an infrastructure reverse DNS query by sending the IP address 955 to the local DNS server 920, to get the domain name 960 associated with this particular IP address 955. The network element 930 then originates an infrastructure forward DNS 970 query for the IP address in question, by sending the domain name 960 to the local DNS server 920. The network element 930 then receives the associated metadata 980. In an embodiment, the metadata 980 is received in a text record.

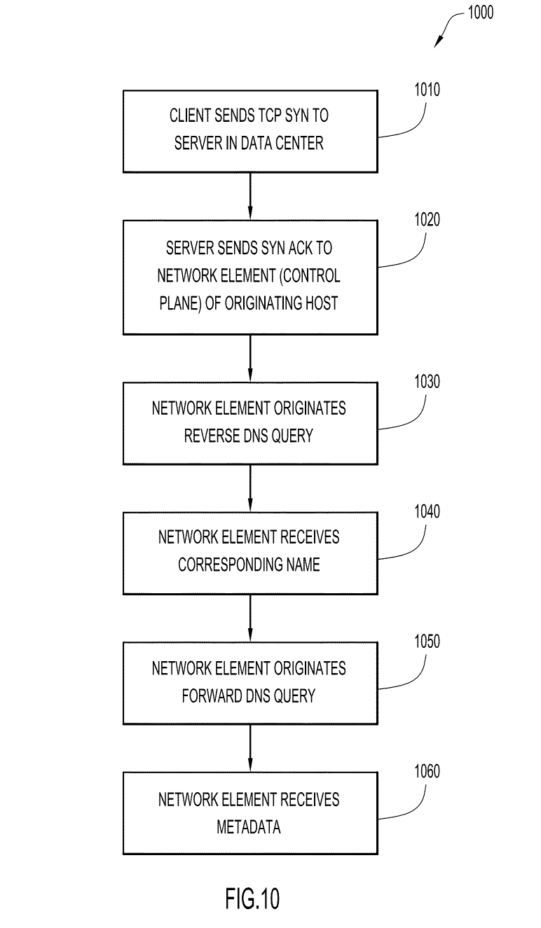

This process is further illustrated in FIG. 10. At 1010, the client sends a TCP SYN message to a server in a data center. At 1020, the server responds by sending back a SYN ACK message to the network element of the originating host. In an embodiment, the SYN ACK is sent to the control plane of the network element. At 1030, the network element originates a reverse DNS query using the IP address. At 1040, the network element receives a name corresponding to the IP address. At 1050, the network element originates a forward DNS query. At 1060, the network element receives the corresponding metadata.

The metadata allows classification of the traffic flow; the classification can then be used to determine one or more appropriate polices for the flow. In an embodiment, a network element (e.g., a switch or router) is upgraded to support the above processing in which the DNS is used as an authoritative source for metadata. Such a network element caches the application metadata for the host in its local storage. The network element examines its local storage to determine if it can identify the application or service, and whether it has the metadata for this application or service. As discussed above, the client's access of the network element generates a reverse DNS query if needed, then a forward DNS query for the IP address of the application or service. In an embodiment, this query is not a query that is directly on behalf of, or visible to, the client. This query represents the network element trying to obtain metadata to be used to determine policy for the flow. In the case of an application or service hosted in the local network, the local DNS server may have the associated metadata stored for the application or service (e.g., application ID and parameters for business requirements, bandwidth, delay, etc.). This information is included in the associated DNS reply. In an embodiment, this information is stored at the DNS in the form of a text record. As a result of this processing, the metadata that is associated with the IP address of the application or service dynamically allows establishment of the appropriate handling (i.e., the appropriate policy) for this flow across the upgraded network element. In one example, the policy could address quality of service (QoS) by marking an appropriate differentiated services control point (DSCP).

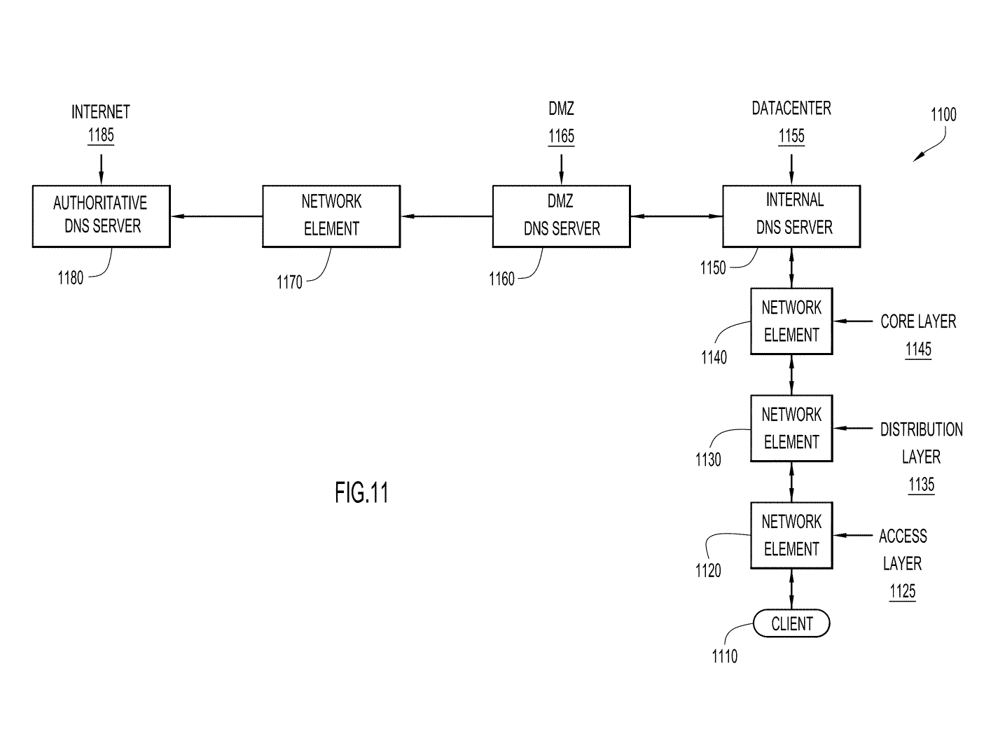

In a more complex embodiment, illustrated in FIG. 11, all the network elements may have been upgraded to support policy enforcement. Policy selection is driven by metadata related to an application or service being accessed by a client 1110, where the metadata is obtained ultimately from a DNS acting as an authoritative source for the metadata. In the illustrated embodiment, components 1110, 1120, 1130, and 1140 may all be within an enterprise or campus network, for example. The network element 1120 in the access layer 1125 may have cached the metadata from previous DNS queries. When accessed by client 1110, the network element 1120 examines its local storage to determine if it can identify the application or service sought by client 1110, and to determine if it has the metadata for this application or service. If not, the access by client 1110 to the access layer network element 1120 generates a reverse DNS query (if needed), then a forward DNS query for the IP address of the application or service. This represents the access layer network element 1120 trying to determine policy for the flow. In this case, the access layer network element 1120 sends the DNS queries to a network element 1130 at the distribution layer 1135.

In the illustrated example, the distribution layer network element 1130 does not know the identity of this application or service. Acting as a recursive DNS server (as this term is defined, for example, by the IETF in RFC 4339), the distribution layer network element 1130 also sends along a reverse query and, if needed, a forward DNS query for the application or service IP address to an upstream network element (a network element 1140 in the core layer 1145, in this example). In this example, the core layer network element 1140 also does not know the IP address of this application or service. Acting as a recursive DNS server for the infrastructure, the core layer network element 1140 sends along a reverse query if necessary, then a forward DNS query for the application or service IP address to the DNS service provided by an internal DNS server 1150. In an embodiment, the internal DNS server may be part of the intranet that includes components 1110, 1120, 1130, and 1140, and may be located in a data center 1155. In such an embodiment, the internal DNS server 1150 may be authoritative for destinations within this intranet.

As an illustration, it may be desirable that traffic from a particular web site should be dropped. This would be expressed by a network or system administrator to an application in the internal DNS server 1150, for example. The internal DNS server 1150 would then execute code to generate metadata that identifies traffic to or from this site as application type “drop”. An update is performed (before the normal TTL expires) for all the downstream network elements 1120, 1130, and 1140. As a result, a policy is now in place at each of the network elements 1120, 1130, and 1140 and, when enforced, effects the dropping of traffic for this site.

Where the application or service sought by client 1110 is outside the intranet, then the internal DNS server 1150 may not have the necessary metadata. If the internal DNS server 1150 does not know the IP address of this application or service, it acts as a recursive DNS server for the infrastructure, and sends a reverse query and a forward DNS query (if necessary) for the application or service IP address to a DMZ DNS server 1160. This server may be located in a so-called demilitarized zone (DMZ) or perimeter network 1165 external to the intranet and datacenter 1155. The DMZ DNS server 1160 may know the domain to which the IP address belongs, and may also have the associated enterprise metadata stored for the application or service (e.g., app ID, business requirements, bandwidth and delay parameters, etc.). If so, this is included in the forward DNS infrastructure reply to the internal DNS server 1150. This information is now cascaded back across all network elements 1120, 1130, and 1150 in the infrastructure, all of which cache the metadata. The network elements 1120, 1130, and 1150 can now use the metadata to choose a policy for this particular flow. As a result, metadata associated with the IP address of this application or service, as stored in DNS, dynamically establishes appropriate handling for this flow across the network using the DNS for metadata storage.

In some circumstances, the DMZ DNS server 1160 may not have the required metadata. If this is the case, the DMZ DNS server 1160 acts as a recursive DNS server for the infrastructure. The DMZ DNS server 1160 sends a reverse query, then a forward DNS query (if necessary) for the application or service IP address to a network element 1170. The network element 1170 may be a border router facing an upstream internet service provider, for example. If the network element 1170 has the necessary metadata cached, then the metadata may be returned to the DMZ DNS server 1160 in a reply to the query from the latter. Again, this information may then be cascaded back across all preceding network elements where the information may be cached, to allow for the choice of an appropriate policy at those devices. In an embodiment, the network element 1170 executes both a DNS-AS client and a DNS-AS proxy. The DMZ DNS server 1160 will interface with the DNS-AS proxy, while the upstream authoritative DNS server 1180 will interface with the DNS-AS client.

If the network element 1170 does not have the necessary metadata, it may send the reverse query, then a forward DNS query (if necessary) for the application or service IP address to the authoritative DNS server 1180. The server 1180 may represent the actual DNS server for the application or service. The server 1180 may be located beyond the border of data center 1155 and the DMZ 1165, and may reside elsewhere in the Internet 1185, for example. In response to the query or queries from the network element 1170, the authoritative DNS server 1180 may provide the required metadata. As before, this information may be cascaded back through all the preceding components where the information may be cached, to allow for the choice of an appropriate policy at those devices.

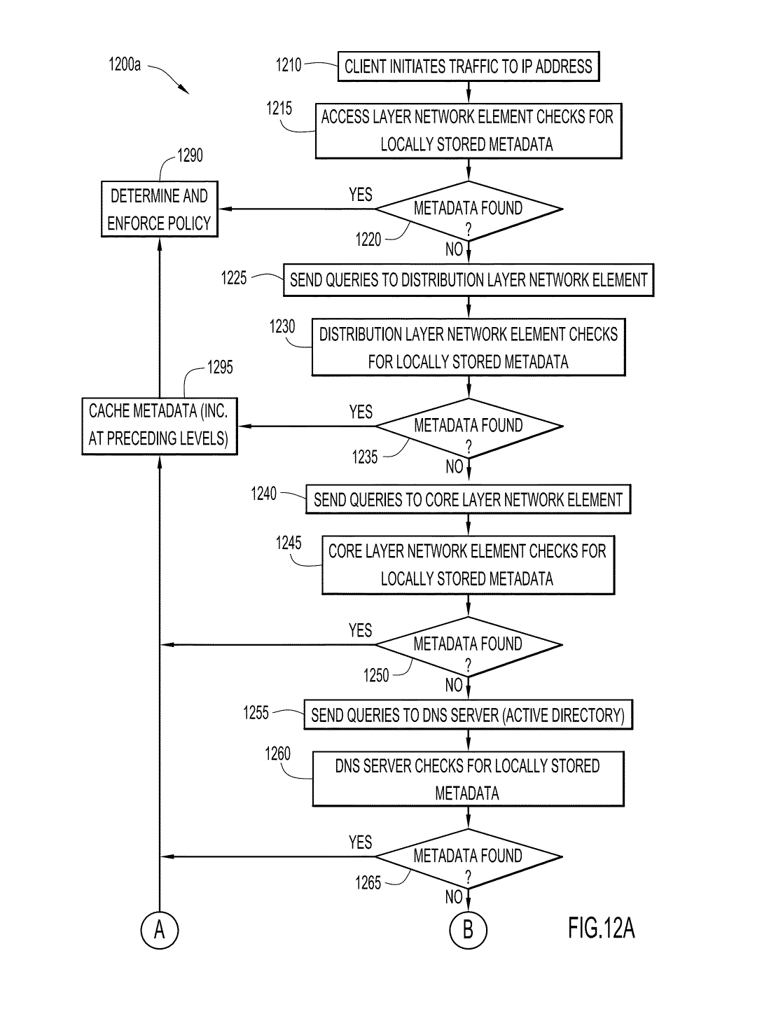

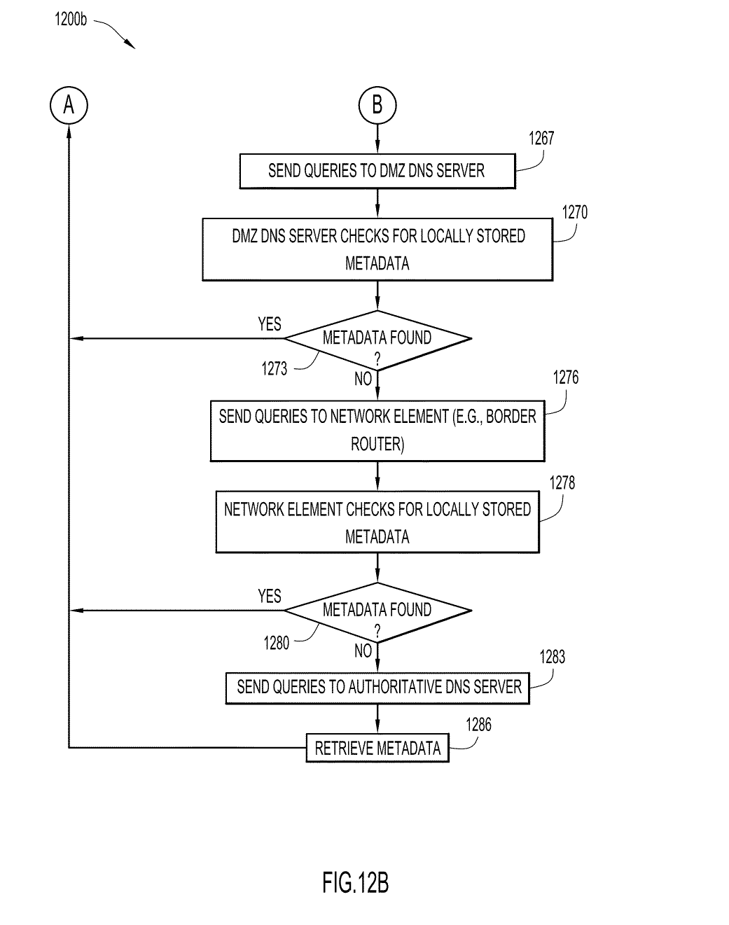

FIGS. 12A and 12B further illustrate the processing of FIG. 11, according to an embodiment. At 1210, a client initiates traffic to an IP address with the goal of accessing a service or application. At 1215, the access layer network element receives the traffic and checks its internal storage for metadata related to the application or service sought by the client. At 1220, a determination is made as to whether the metadata is present at this network element. If so, then at 1290 one or more policies can be determined on the basis of the metadata and enforced. Otherwise the process continues at 1225.

At 1225, reverse and forward queries are sent from the network element at the access layer to a network element at the distribution layer. At 1230, the distribution layer network element checks to see if the necessary metadata is stored locally at this network element. If the metadata is determined to be present at 1235, then at 1295 the metadata is cached at the distribution layer network and is also provided to the network element at the preceding level (i.e., to the access layer network element) for caching there. If the metadata is not found locally at the distribution layer network element, then the process continues at 1240.

At 1240, reverse and forward queries are sent from the network element at the distribution layer to a network element at the core layer. At 1245, the core layer network element checks to see if the necessary metadata is stored locally at this network element. If the metadata is determined to be present at 1250, then at 1295 the metadata is cached at this network element and is also provided to the network elements at the preceding levels (i.e., to the access and distribution layer network elements) for caching at those locations. If the metadata is not found locally at the core layer network element, then the process continues at 1255.

At 1255, reverse and forward queries are sent from the network element at the core layer to an internal DNS server. At 1260, the internal DNS server checks to see if the necessary metadata is available locally at this server. If the metadata is determined to be present at 1265, then at 1295 the metadata is provided to the network elements at the preceding levels (i.e., to the core, access, and distribution layer network elements) for caching there. If the metadata is not found locally at the internal DNS server, then the process continues at 1267. At this point, reverse and forward queries are sent from the internal DNS server to a DNS server in the DMZ (DMZ DNS server). At 1270, this server checks for locally stored metadata. If the metadata is found at 1273, then processing continues at 1295. If not, the processing continues at 1276. Here, queries are sent from the DMZ DNS server to a network element such as a border router. This network element checks for locally stored metadata. A determination is made at 1280 as to whether the metadata is present. If so, processing continues at 1295. Otherwise, processing continues at 1283. At this stage, the metadata in question has not been found in any of the preceding components. At 1283, queries (a reverse query and a forward query if necessary) are therefore sent to an authoritative server (e.g., the actual DNS server for the application or service). The metadata is retrieved at 1286. The metadata, once obtained at this server, is then provided (at 1295) to the network elements at the preceding levels for caching at those locations.

There are alternative ways in which an application may be identified. Internet-facing and/or wide area network (WAN)-facing routers could also use capabilities such as Next Generation Network-Based Application Recognition (NBAR2) and/or deep packet inspection (DPI) to inspect packet streams, infer the application in use via that inspection, and apply metadata as needed for that traffic type. Other functions may be used in a similar manner, such as SourceFire, Snort, or a virtual network analysis module (vNAM), as would be understood by persons of ordinary skill in the art. The appropriate metadata could then be obtained from the DNS as discussed above.

In an embodiment, metadata can be served back to network elements at lower levels by external DNS systems (cloud or Internet-based). This could be used, for example, by a service like Google Docs or DropBox to serve back a known OpenApp ID, which the network elements could use.

As discussed above, metadata may include a variety of parameters, such as those relating to business requirements, jitter, delay, and bandwidth requirements, for example. The metadata may also include information on known ports that the application or service may use. Knowing this could help a network element to drive policy decisions with more granularity. Moreover, there is no reason that this has to be limited to one known port per application, service, or server. Various embodiments could serve back metadata that identifies multiple ports if the given application, service, or server hosts more than one function.

In an embodiment, application metadata may be created or edited by manipulation of a DNS service resource records. The resource records (RRs) contain the application metadata. For example, the administrator may add a text line describing the QoS policy key, based on RFC 4594 Configuration Guidelines for Differentiated Services (DiffServ) Classes. He may also add a text line describing the security policy key, based on IEEE 802.1x Authentication with access control lists (ACLs) and a Filter-Id Attribute e.g. for Network Control based on RFC 2474. He may also add a text line defining a differentiated services control point, e.g., TEXT “DSCP=48” or use the syntax described within “RFC 4594” for Application Classes. When the editing is completed, a serial number for the zone file may be incremented.

As an embodiment, the RRs may be represented as a completed zone file, as in this example:
[root@ns2 slaves]# cat toocoolforyou.net.zone
$ORIGIN.
$TTL 3600; 1 hour
toocoolforyou.net IN SOA ns1.f1-online.net. root.f1-online.net. (
   2013102802; serial
   10800; refresh (3 hours)
   3600; retry (1 hour)
   604800; expire (1 week)
   3600; minimum (1 hour))
   )
   NS ns1.f1-online.net.
   NS ns2.f1-online.net.
   NS ns1.m-online.net.
   NS ns2.m-online.net.
   A 193.34.28.108
   MX 10 mx1.toocoolforyou.net.
   MX 10 mx2.toocoolforyou.net.
$ORIGIN toocoolforyou.net.
csdn A 193.34.28.120
   TEXT DSCP=48
ftp A 193.34.28.109
   TEXT DSCP=10
ftp2 A 193.34.28.110
   TEXT DSCP=12
inception A 193.34.28.111
mx1 A 193.34.29.107
mx2 A 193.34.28.107
www A 193.34.28.108

### Policy Creation and Enforcement

Once the metadata is obtained for a particular application or service, one or more appropriate policies may be enforced. In an embodiment, the policies that may be invoked are provided by a system administrator to the SDN controller. In an embodiment, the policies are therefore defined on the SDN controller, and are pushed from there to the infrastructure as described above. Moreover, the applicability of a policy to a particular application or service or category thereof may ultimately be decided by an administrator. Such an administrator makes these decisions by considering the characteristics of the application or service to the organization, and determining how the application or service (and communications therewith) should be treated with respect to a particular device. This analysis yields desired results, or intent, as to how traffic should be handled. This intent is embodied in policies stored at the SDN controller and mapped to a particular application or service.

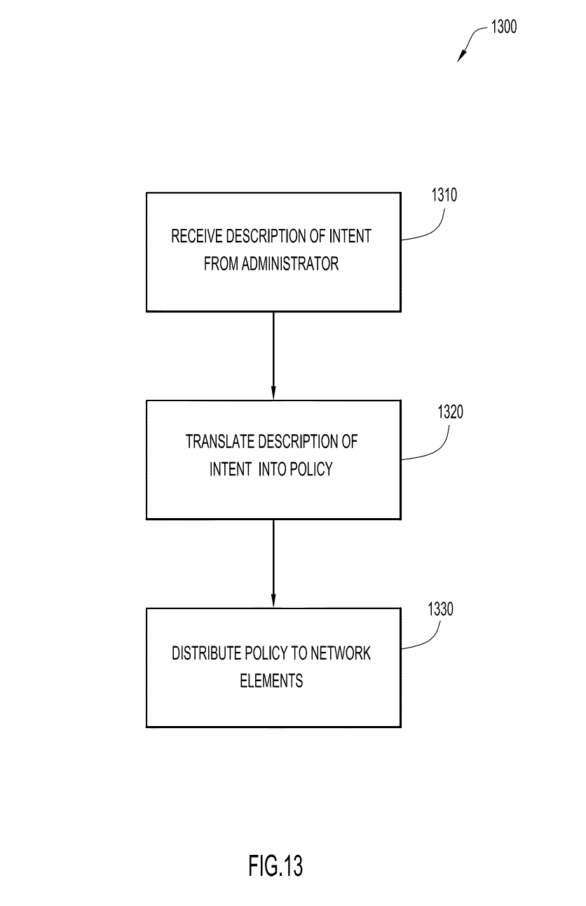

The process of policy generation and distribution is illustrated in FIG. 13, according to an embodiment. At 1310, a description of one or more network constraints is received at the SDN controller from an administrator. At 1320, the description of the one or more network constraints is translated by the SDN controller into a policy description. At 1330, the policy is distributed to network elements. As noted above, the policy may be specified as a policy language such as C3PL.

Alternatively, policies can be pre-positioned into network elements in an embodiment. This can be done by the SDN controller. Alternatively, the policies could be retrieved on demand from the SDN controller if desired, e.g., if device capacity is very low, or policy count is very high, as an aid to solution scalability for large deployments. The policies may be embodied in an appropriate data structure, as would be known to a person of ordinary skill in the art. An example of this would be a binding table that relates an application ID to a policy for that application.

The binding table is created and used within a network element, to map the metadata delivered via the DNS-AS mechanism, with the appropriate policy actions and other related information that may leverage this metadata. The binding table is created from multiple potential sources within a given platform that may contend to enter data into this table—of which DNS-AS is one potential source. The binding table allows for the metadata that describes the application or function in use to be linked to the corresponding policy or policies regarding what possible treatment, or treatments, should be applied to any application, device, or user network flows that match the criteria within that entries, or entries, within the binding table. For example, the metadata derived from DNS-AS matches application “X”, which the organization has indicated should receive policy treatment “Y”. A corresponding entry is made into the binding table within the device to this metadata “X” to policy “Y”. This binding table entry could be made before the user/application flow appears in some cases, and in other cases could be instantiated by the appearance of the DNS lookup for the network flow by a user, application, or device, and the associated metadata retrieval by the network element about the application in use. In an embodiment, the binding table entry may be created as a software construct within the network element in most cases, and then subsequently formatted by the platform for programming into the device-level hardware implementation, with most platforms then providing for the subsequent data-plane handling of the actual traffic application/user/device traffic flow (with appropriate policy treatment) in hardware, as an aid to scalability and performance.

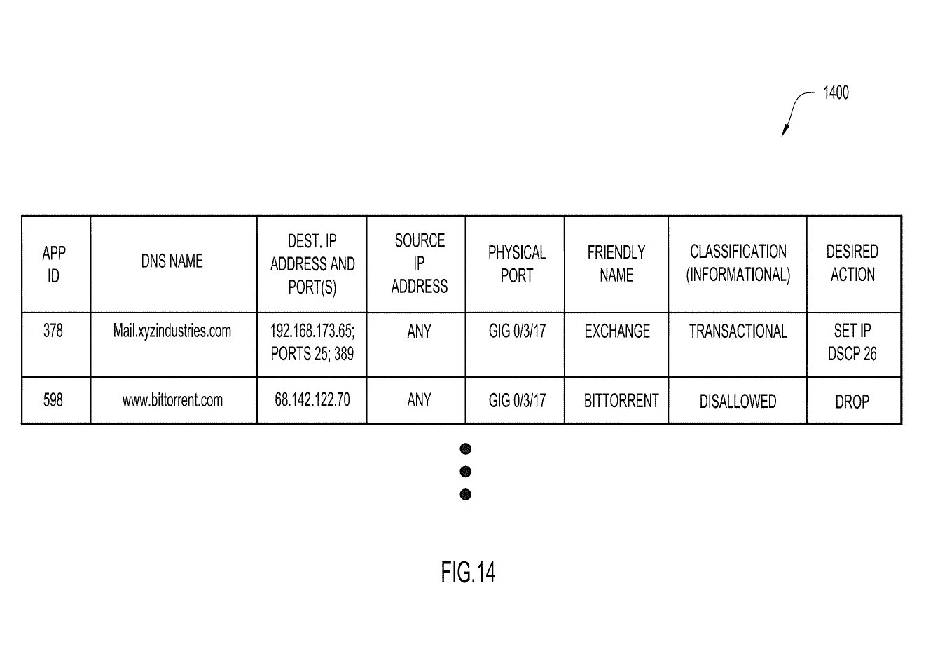

An example of a binding table is presented as FIG. 14. A given application is identified by an App ID and DNS name, and has the other attributes shown (destination IP address and port(s), source IP address, physical port, friendly name, and classification). For each application, there is a desired action that represents the policy to be enforced with respect to traffic for the application. For the first application, the IP differentiated services code point (DSCP) is set to 26. For the second application, traffic is to be dropped.

The mapping from destination address and/or other metadata (or category thereof) to a policy resource record (RR) can be encoded in a network element in any manner known to persons of ordinary skill in the art. In an embodiment, the mapping can be encoded with a PTR RR from the destination IP address to the host's fully qualified domain name (FQDN), and an RR containing the metadata under the host FQDN. An example of this is as follows:

1.2.0.192.in-addr.arpa PTR ftp-host.example.com

1.2.0.192.in-addr.arpa PTR ftp-host.example.com

ftp-host.example.com A 192.0.2.1

TEXT “DSCP=12”

Alternatively, the mapping can be encoded with an RR containing the policy under reverse zone entry from the destination IP address, as follows:

1.2.0.192.in-addr.arpa PTR ftp-host.example.com

TEXT “DSCP=12”

Metadata about specific ports at a destination address can also be encoded in the text record, as shown in this example:

1.2.0.192.in-addr.arpa PTR ftp-host.example.com
TEXT “port=ftp; DSCP=12”
TEXT “port=http; DSCP=20”

The semantics of the text may depend on the domain where it is found. In an embodiment, a dedicated RR type may be used instead of the TEXT type. In this case the data carried by the RR type encodes the policy information.

A policy may be applied by a network element, forwarding engine, an operating system, or an application. The forwarding engine, operating system or application can poll the DNS server for domain info on a regular interval or based on demand. The TEXT files can then be extracted from the DNS lookup, e.g., dig TEXT+short ftp2.toocoolforyou.net. The policy can be applied based on an extracted TEXT key.

Another use case would be to use “Snort OpenAppID” as a TEXT record, where SourceFire is a major contributor. See:

http://www.snort.org/docs

http://blog.snort.org/2014/03/firing-up-openappid.html

http://www.networkworld.com/article/2226547/cisco-subnet/application-awareness-goes-open-source-snort-openappid.html

An example of this for the WWW protocol would be as follows:
OpenAppID for WWW:
cat appMapping.data|grep HTTP
676 HTTP 9 0 0 http http
1122 HTTPS 20129 0 0 https https

An example of this for the File Transfer Protocol (FTP) would be as follows:
OpenAppID for FTP:
cat appMapping.data|grep FTP
165 FTP 8 0 0 ftp ftp
166 FTP Data 36 0 0 ftp-data ftp-data

The configuration of a DNS server to support the processing described herein may be implemented as follows, for example:
cat toocoolforyou.net.zone
$ORIGIN.
$TTL 3600; 1 hour
toocoolforyou.net IN SOA ns1.f1-online.net. root.f1-online.net. (
   2960756817; serial
   10800; refresh (3 hours)
   3600; retry (1 hour)
   604800; expire (1 week)
   3600; minimum (1 hour))
)
   NS ns1.f1-online.net.
   NS ns2.f1-online.net.
   A 193.34.28.108
   MX 10 mx1.toocoolforyou.net.
   MX 10 mx2.toocoolforyou.net.
   TEXT;v=spfl mx ip4:193.34.28.0/22˜all;
$ORIGIN toocoolforyou.net.
_autodiscover._tcp SRV 0 0 443 inception
csdn A 193.34.28.120
   TEXT;DSCP=48;
ftp A 193.34.28.109
   TEXT; OpenAppID=165;
ftp2 A 193.34.28.110
   TEXT;DSCP=12;
inception A 193.34.28.111
mail A 193.34.28.107
   A 193.34.29.107
mx1 A 193.34.29.107
mx2 A 193.34.28.107
proxy A 192.168.167.245
   A 192.168.168.245
proxy1 A 192.168.167.245
proxy2 A 192.168.168.245
www A 193.34.28.108
   TEXT;OpenAppID=676

Examples of DNS client lookups may include the following:
[root@ns2 named]# dig TEXT+short ftp.toocoolforyou.net
“OpenAppID=165”
[root@ns2 named]# dig TEXT+short www.toocoolforyou.net
“OpenAppID=676”

As articulated in a binding table, a particular policy may require a client to drop a traffic flow if accessing a particular application, for example. If a device fails to implement a required policy, the device can signal this failure to the APIC-EM or other SDN controller for alerting of an administrator, for possible remedial action.

Implementation of a policy on a forwarding engine may, in an embodiment, use the concept of administrative distance (normally applied to routers) for prioritization of policy discovery. This would allow box-level prioritization of policy sources. Such a configuration may appear as follows, for example:
Routing:
[C] Directly connected 0
[S] Static local interface 0
[S] Static next hop router 1
[D] EIGRP summary route 5
[B] eBGP 20
[EX] EIGRP Internal 90
[I] IGRP 100
[O] OSPF 110
[i] ISIS 115
[R] RIP 120
[E] EGP 140
[o] ODR 160
[ ] EIGRP External 170
[B] iBGP 200
[ ] Unknown 255
AppID:
[S] Static configured 0
[A] APIC derived 100
[T] SGT derived 110
[S] SourceFire 120
[0] SNORT 130
[N] NBAR 140
[D] DNS-AS 200
[ ] Unknown 255

Based on the application OpenAppID, application policies can be triggered, like access control lists (ACLs), QoS marking, or event chain services, while influencing the next hop with policy based routing. An example of an ACL policy is as follows:
Today, static ports:
ip access-list extended ACL-IPv4-Exchange-in
remark------SMTPS---
permit tcp any host 193.34.28.111 eq 587
remark------pop3---
permit tcp any host 193.34.28.111 eq 995
remark------imap---
permit tcp any host 193.34.28.111 eq 993
remark------OWA---
permit tcp any host 193.34.28.111 eq www
permit tcp any host 193.34.28.111 eq 443
Using DNS as an authoritative source:
ip access-list extended ACL-IPv4-Exchange-in
remark------SMTPS---
permit tcp any host 193.34.28.111 eq OpenAppID-SMTPS
remark------pop3---
permit tcp any host 193.34.28.111 eq OpenAppID-POP3
remark------imap---
permit tcp any host 193.34.28.111 eq OpenAppID-IMAP
remark------OWA---
permit tcp any host 193.34.28.111 eq OpenAppID-HTTP
permit tcp any host 193.34.28.111 eq OpenAppID-HTTPS

The process flow at a network element ND may proceed as follows:
1) ND receives inbound packet
2) finds it does not have a policy for the dst-addr in the packet
3) does a reverse query to get the FQDN for dst-addr
4) does a TEXT RR query to get the key (e.g., DSCP, OpenAppID, . . . )
5) looks up the policy based on the key
6) optionally saves the policy key for future use (this would allow skipping of steps 2-5 for subsequent traffic to dst-addr.

In an embodiment, some of the processes described above are performed at one or more network elements. At each element, the processing may be performed in accordance with software or firmware (or a combination thereof) executing on one or more processors. Each network element may comprise its own computing system. Such a computing system may include one or more memory devices. The memory is in communication with one or more processors and network interfaces. The processors and ports enable communication with other network elements. The processors may include one or more Application Specific Integrated Circuits (ASICs) that are configured with digital logic gates to perform various networking and security functions (routing, forwarding, deep packet inspection, etc.)

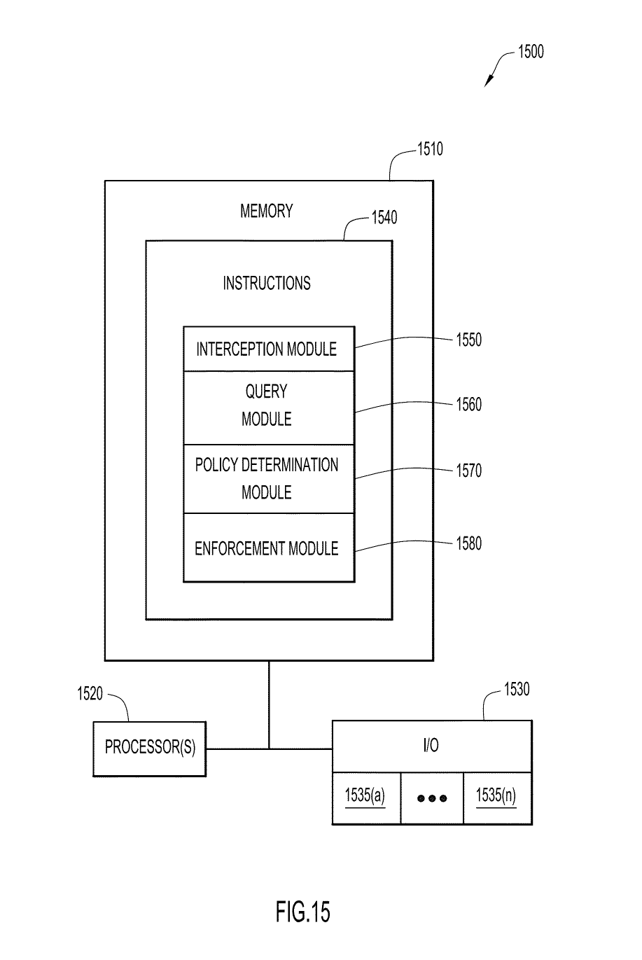

Such a computing system for a network element is illustrated in FIG. 15, according to an embodiment. Computing system 1500 includes one or more memory devices, shown collectively as memory 1510. Memory 1510 is in communication with one or more processors 1520 and with one or more input/output (I/O) units 1530. An example of an I/O unit is a network processor unit that may have associated network ports 1535a-1535n. In an embodiment, a network element may communicate with a client, another network element or other component or a network infrastructure via I/O 1530. The I/O 1530 may include one or more Application Specific Integrated Circuits (ASICs) that are configured with digital logic gates to perform various networking and security functions (routing, forwarding, deep packet inspection, etc.).

Memory 1510 may comprise read only memory (ROM), random access memory (RAM), magnetic disk storage media devices, optical storage media devices, flash memory devices, electrical, optical, or other physically tangible (i.e., non-transitory) memory storage devices. Memory 1510 stores data as well as executable instructions 1540. Instructions 1540 are executable on processor(s) 1520. The processor(s) 1520 comprise, for example, a microprocessor or microcontroller that executes instructions 1540. Thus, in general, the memory 1510 may comprise one or more tangible (non-transitory) computer readable storage media (e.g., memory device(s)) encoded with software or firmware that comprises computer executable instructions. When the instructions are executed (by the processor(s) 1520) the software or firmware is operable to perform the operations described herein.

In the illustrated embodiment, the executable instructions 1540 may include an interception module, whose instructions are configured to intercept a DNS query or other network traffic from a client. Instructions 1540 may also include a query module 1550 whose instructions are configured to issue forward and reverse DNS queries to other components of the network infrastructure to obtain the necessary metadata. Instructions 1540 may also include a policy determination module 1570 whose instructions are configured to determine an appropriate policy to apply to traffic related to the application or service being accessed by the client. As described above, this determination is based on the metadata for the application or service. Instructions 1540 may also include an enforcement module 1580 whose instructions are configured to implement the identified policy.

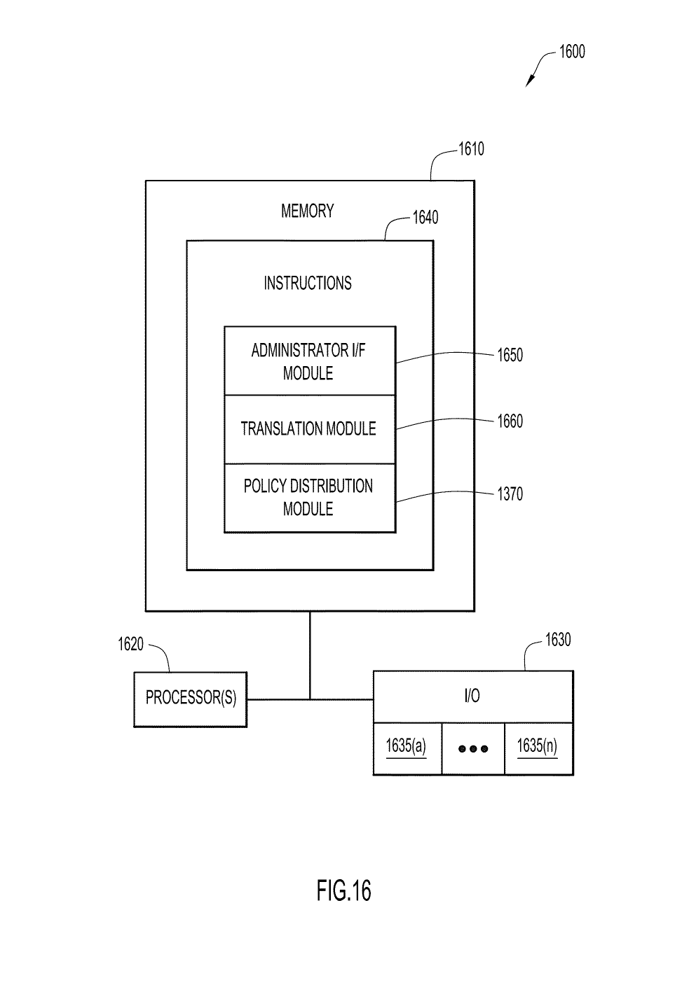

Processing at a SDN controller may also be implemented in software, firmware, or a combination thereof. An SDN controller is illustrated as a computing system in FIG. 16, according to an embodiment. Computing system 1600 includes one or more memory devices, shown collectively as memory 1610. Memory 1610 is in communication with one or more processors 1620 and with one or more input/output (I/O) units 1630. An example of an I/O unit is a network processor unit that may have associated network ports 1635a-1635m. In an embodiment, an SDN controller may communicate with a network element or other component of a network infrastructure via I/O 1630. The I/O 1630 may include one or more Application Specific Integrated Circuits (ASICs) that are configured with digital logic gates to perform various networking and security functions (routing, forwarding, deep packet inspection, etc.).

Memory 1610 may comprise read only memory (ROM), random access memory (RAM), magnetic disk storage media devices, optical storage media devices, flash memory devices, electrical, optical, or other physically tangible (i.e., non-transitory) memory storage devices. Memory 1610 stores data as well as executable instructions 1640. Instructions 1640 are executable on processor(s) 1620. The processor(s) 1620 comprise, for example, a microprocessor or microcontroller that executes instructions 1640. Thus, in general, the memory 1610 may comprise one or more tangible (non-transitory) computer readable storage media (e.g., memory device(s)) encoded with software or firmware that comprises computer executable instructions. When the instructions are executed (by the processor(s) 1620) the software or firmware is operable to perform the operations described herein.

In the illustrated embodiment, the executable instructions 1640 may include a module 1650, whose instructions are configured to provide an interface to an administrator through which an intended policy may be provided. Instructions 1640 may also include a translation module 1660 whose instructions are configured to translate the intended policy provided by the administrator into an actual enforceable policy. Instructions 1640 may also include a policy distribution module 1670 whose instructions are configured to distribute policy network elements and other enforcement points in the network infrastructure.

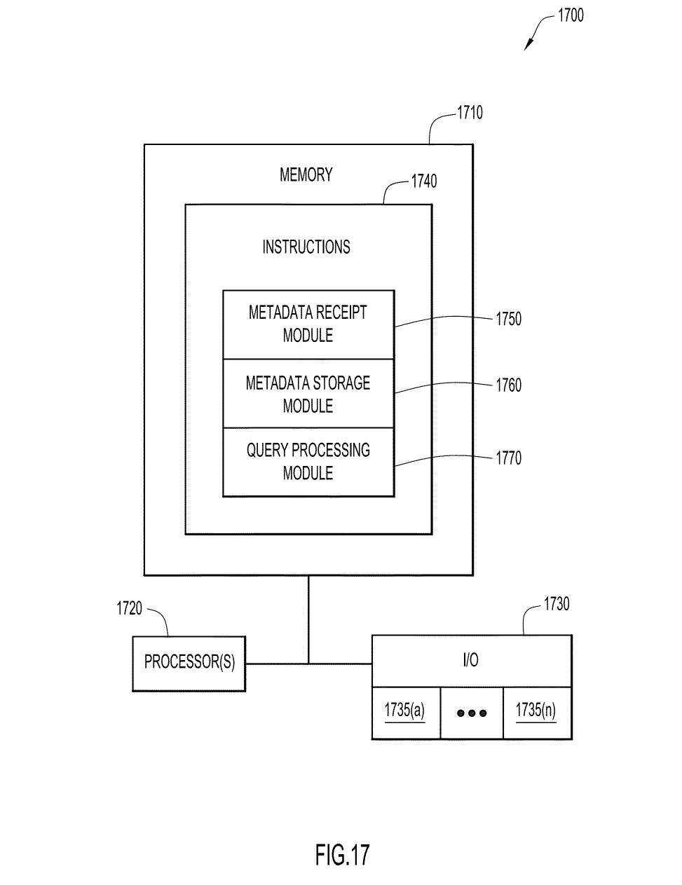

Processing at a DNS server may also be implemented in software, firmware, or a combination thereof. A DNS server is illustrated as a computing system in FIG. 17, according to an embodiment. Computing system 1700 includes one or more memory devices, shown collectively as memory 1710. Memory 1710 is in communication with one or more processors 1720 and with one or more input/output (I/O) units 1730. An example of an I/O unit is a network processor unit that may have associated network ports 1735a-1735p. In an embodiment, a DNS server may communicate with a network element or other component of a network infrastructure via I/O 1730. The I/O 1730 may include one or more ASICs that are configured with digital logic gates to perform various networking and security functions (routing, forwarding, deep packet inspection, etc.).

Memory 1710 may comprise ROM, RAM, magnetic disk storage media devices, optical storage media devices, flash memory devices, electrical, optical, or other physically tangible (i.e., non-transitory) memory storage devices. Memory 1710 stores data as well as executable instructions 1740. Instructions 1740 are executable on processor(s) 1720. The processor(s) 1720 comprise, for example, a microprocessor or microcontroller that executes instructions 1740. Thus, in general, the memory 1710 may comprise one or more tangible (non-transitory) computer readable storage media (e.g., memory device(s)) encoded with software or firmware that comprises computer executable instructions. When the instructions are executed (by the processor(s) 1720) the software or firmware is operable to perform the operations described herein.

In the illustrated embodiment, the executable instructions 1740 may include a module 1750, whose instructions are configured to receive metadata from, for example, a provider of the application or service. Instructions 1740 may also include a metadata storage module 1750 whose instructions are configured to store the metadata in a manner that links or otherwise associates the metadata with a particular application or service. Instructions 1740 may also include a query processing module 1770 whose instructions are configured to receive forward and/or reverse queries from a network element and respond by sending the appropriate metadata to the network element.

In summary, in one form a method is provided comprising: receiving, at a domain name system (DNS) server, metadata related to a network application or service; receiving one or more queries from a network element; sending the metadata to the network element in response to the one or more queries.

In another form, one or more non-transitory computer readable storage media may be encoded with software comprising computer executable instructions that, when executed, are operable to: receive metadata related to a network application or service; receive one or more queries from a network element; and send the metadata to the network element in response to the one or more queries, wherein the instructions are executed at a domain name system (DNS) server.

In another form, an apparatus may comprise: a network interface to communicate over a network; and a processor coupled to the network interface. The processor is configured to: receive metadata related to a network application or service; receive one or more queries from a network element; send the metadata to the network element in response to the one or more queries, wherein the instructions are executed at a domain name system (DNS) server.

In another form, the a method is provided comprising: at a network element in a network, intercepting a domain name query from a client; obtaining, from a domain name system server, metadata associated with a network application or service that is the object of the domain name query; determining a policy to enforce, wherein the determination of the policy is based on the metadata; and enforcing the policy with respect access by the client of the network application or service.

In another form, one or more non-transitory computer readable storage media are encoded with software comprising computer executable instructions that, when executed, are operable to: intercept a domain name query from a client; obtain, from a domain name system server, metadata associated with a network application or service that is the object of the domain name query; determine a policy to enforce, wherein the determination of the policy is based on the metadata; and enforce the policy with respect access by the client of the network application or service.

In another form, a network element may comprise: a network interface to communicate over a network; and a processor coupled to the network interface. The processor is configured to: intercept a domain name query from a client; obtain, from a domain name system server, metadata associated with a network application or service that is the object of the domain name query; determine a policy to enforce, wherein the determination of the policy is based on the metadata; and enforce the policy with respect access by the client of the network application or service.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Functional building blocks are used herein to illustrate the functions, features, and relationships thereof. At least some of the boundaries of these functional building blocks have been arbitrarily defined herein for the convenience of the description. Alternate boundaries may be defined so long as the specified functions and relationships thereof are appropriately performed. The breadth and scope of the claims should not be limited by any of the example embodiments disclosed herein.

What is claimed is:

1. A method comprising:
at a network element in a network, intercepting a domain name query from a client;
obtaining, from a domain name system server, metadata associated with a network application or service that is the object of the domain name query;
determining a policy to enforce, based on the metadata; and
enforcing the policy with respect to access by the client of the network application or service.

2. The method of claim 1, wherein the intercepting, obtaining, determining and enforcing are performed at one of:
a router;
a switch; or
a forwarding engine.

3. The method of claim 1, wherein obtaining comprises obtaining the metadata by recursively accessing one or more of a distribution layer network element, a core layer network element, a network element running a domain name system authoritative source proxy, and/or an authoritative domain name system server in the network.

4. The method of claim 3, further comprising:
caching the obtained metadata.

5. The method of claim 1, wherein the metadata comprises an identifier of the network application or service.

6. The method of claim 5, wherein the metadata further comprises one or more parameters respectively describing one or more of a throughput requirement, a quality of service requirement, a security requirement, a bandwidth requirement, a signal loss requirement, a delay requirement, or a jitter requirement.

7. The method of claim 1, further comprising:
receiving the policy from a software defined network controller in the network.

8. One or more computer readable non-transitory storage media encoded with software comprising computer executable instructions that, when executed, are operable to:
intercept a domain name query from a client;
obtain, from a domain name server, metadata associated with a network application or service that is the object of the domain name query;
determine a policy to enforce, based on the metadata; and
enforce the policy with respect to access by the client of the network application or service.

9. The non-transitory computer readable storage media of claim 8, wherein the instructions are executed at a network element that comprises one of:
a router;
a switch; or
a forwarding engine.

10. The non-transitory computer readable storage media of claim 8, wherein the instructions operable to obtain the metadata comprise instructions operable to initiate recursively accessing one or more of a distribution layer network element, a core layer network element, and/or an authoritative domain name system server in the network.

11. The non-transitory computer readable storage media of claim 10, further comprising executable instructions that, when executed, are operable to:
locally cache the obtained metadata.

12. The non-transitory computer readable storage media of claim 8, wherein the instructions operable to obtain the metadata comprise instructions operable to obtain metadata that comprises an identifier of the network application or service.

13. The non-transitory computer readable storage media of claim 12, wherein the instructions operable to obtain the metadata further comprise instructions operable to obtain metadata that comprises one or more parameters respectively describing one or more of a throughput requirement, a quality of service requirement, a security requirement, a bandwidth requirement, a signal loss requirement, a delay requirement, or a jitter requirement.

14. The computer readable non-transitory storage media of claim 8, further comprising executable instructions that, when executed, are operable to:
receive the policy from a software defined network controller in the network.

15. A network element comprising:
a network interface to communicate over a network; and
a processor coupled to the network interface, and configured to:
intercept a domain name query from a client;
obtain, from a domain name server, metadata associated with a network application or service that is the object of the domain name query;
determine a policy to enforce, based on the metadata; and
enforce the policy with respect to the access by the client of the network application or service.

16. The network element of claim 15, wherein the network element comprises one of:
a router;
a switch; or
a forwarding engine.

17. The network element of claim 15, wherein the processor is configured to obtain the metadata by initiating a process of recursively accessing one or more of a distribution layer network element, a core layer network element, and/or an authoritative domain name system server in the network.

18. The network element of claim 17, wherein the processor is further configured to:
locally cache the obtained metadata.

19. The network element of claim 15, wherein the metadata comprises an identifier of the network application or service.

20. The network element of claim 19, wherein the metadata further comprises one or more parameters respectively describing one or more of a throughput requirement, a quality of service requirement, a security requirement, a bandwidth requirement, a signal loss requirement, a delay requirement, and a jitter requirement.
